(19) United States
(12) Patent Application Publication
(10) Pub. No.: US 2009/0053375 A1
(43) Pub. Date: Feb. 26, 2009

(54) System and method for making blended frozen products with liquid nitrogen

(76) Inventor: Keith Johnson, Naples, FL (US)

Correspondence Address: STOCKWELL & SMEDLEY, PSC, 861 CORPORATE DRIVE, SUITE 200, LEXINGTON, KY, 40503, US

(21) Appl. No.: 12/072,387

(22) Filed: Feb. 26, 2008

Related U.S. Application Data
(63) Continuation-in-part of application No. 11/894,241, filed on Aug. 20, 2007.

(51) Int. Cl. A23G 9/20; B01F 15/02; B01F 15/06

(52) U.S. Cl. 426/474; 366/167.1; 366/144

(57) ABSTRACT

A system and method for making frozen, blended confections utilize liquid nitrogen to partially freeze the confection. A liquid or slurry is first placed in a blender and during blending, liquid nitrogen is introduced at a controlled rate so that the liquid partially freezes and the liquid nitrogen is exhausted out the top of the blender in a visually exciting manner. The blending action and the delivery of liquid nitrogen is synchronized by a computer-controlled algorithm to ensure consistent results.

### RELATED APPLICATIONS

The applications is related to and claims priority from U.S. patent application Ser. No. 11/894,241 filed Aug. 20, 2007, the disclosure of which is incorporated by reference in its entirety.

### BACKGROUND OF THE INVENTION

1. Field of the Invention

The present invention relates generally to frozen confections and, more particularly, with making such confections with liquid nitrogen.

2. Description of Related Art

Traditionally, milkshakes, smoothies and the like are made in large volumes in an automated mixer and dispenser. A customer is served one by simply dispensing the partially frozen liquid into a cup which is presented to the customer. Although cookie pieces, candies, fruit, etc. may be blended in before being served, the frozen portion of the drink is typically mass-produced before hand. Alternatively, some smoothies may sometimes be made individually to a customer's order but this usually involves blending ice cubes in with other liquids to chill the drink. Similarly, ice cream is usually manufactured beforehand in large quantities that are then individually served upon a customer's order.

Regardless of the exact method or techniques that have been used in the past, making and serving frozen drinks or ice cream of this nature have been relatively unexciting and often performed outside the view or awareness of the customer. Accordingly, there exists a need for a system and method of making frozen drinks and ice cream that involves the customer's attention and can be performed for each customer's enjoyment and pleasure. Furthermore, there is the need for a system that produces such drinks with consistent quality without extensive training of the operators.

### BRIEF SUMMARY OF THE INVENTION

Embodiments of the present invention relate to a system and method for making frozen, blended confections that utilize liquid nitrogen to partially freeze the confection. A liquid or slurry is first placed in a blender and during blending, liquid nitrogen is introduced at a controlled rate so that the liquid partially freezes and the liquid nitrogen is exhausted out the top of the blender in a visually exciting manner.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF DRAWINGS

FIG. 1 depicts a blender adapted according to the principles of the present invention.

FIG. 2 depicts a top for a blender in accordance with the principles of the present invention.

FIG. 3 depicts embodiments of the present invention in operation.

FIG. 4 depicts another embodiment of the present invention.

FIG. 5 depicts an algorithm of a computer controlled blender in accordance with the principles of the present invention.

FIG. 6 depicts an alternative blender lid in accordance with the principles of the present invention.

FIG. 7 depicts a block-level view of embodiments of the present invention.

### DETAILED DESCRIPTION OF INVENTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

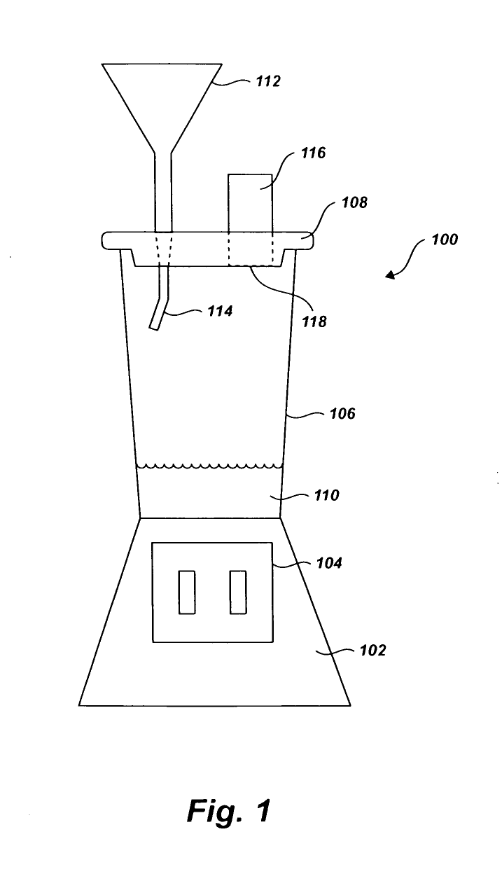

FIG. 1 illustrates a blender or mixer apparatus 100 adapted in accordance with the principles of the present invention. This blender may be used to mix or blend drinks or other confections from a variety of materials. Although the term “smoothie” is used throughout the present specification to refer to one example type of drink that may be made, it is intended that this term cover milkshakes, smoothies, similar partially frozen confections and the like. In some embodiments, individual servings of ice cream may actually be made for serving a customer and, therefore, the use of the term “smoothie” is intended to encompass ice cream as well. Thus, there is a wide range of base materials that may be introduced to the blender that provides the flavor and texture of the resulting confection. For example, fruit juice may be used, a combination of fruit juice and fruits is also contemplated, diary products of varying fat content may also be used, and specially formulated protein or other powder and water may be used as well, without departing from the scope of the present invention. Additionally, nuts, candy pieces, cookie pieces and the like may be added to further provide other flavors and textures.

The blender 100 includes a base 102 having a motor and controls 104 that, as is routinely known in the art, causes a set of blades to spin that are located at the bottom of the blender container 106. This action causes the content 110 of the blender to be agitated and mixed together and in some instances also chops the contents 110. The controls 104 can include a number of different settings that cause the blades to spin at various speeds. The controls 104 may even include a variable control that manually adjusts the speed of the blade such as through turning a knob. Blenders may also include compensators that automatically maintain the correct speed independent of the consistency of the product being blended.

The blender 100 has an adapted lid 108 particularly formed in accordance with the principles of the present invention. The lid 108 includes a fill tube 112 and an exhaust chimney 116. The fill tube 112 communicates fluid to the container 106 via the discharge outlet 114. The container 106 communicates exhaust gases to the chimney 116 though an opening 1118 located at the bottom of the chimney 116. In this manner, liquid nitrogen, or similar cryogenic fluid, may be introduced into the container 106 via the discharge outlet 114 and the resulting vapors are forcefully exhausted out the chimney 116 when the liquid nitrogen boils away.

By the addition of the liquid nitrogen to the contents 110 of the container 106, a blended drink or other confection, such as a smoothie, may be created that is partially frozen. As mentioned such a drink can include items such as smoothies and milkshakes. Of particular benefit is the size of the chimney 116 that directs the exhaust vapors upward from the blender 100 in a forceful, exciting manner.

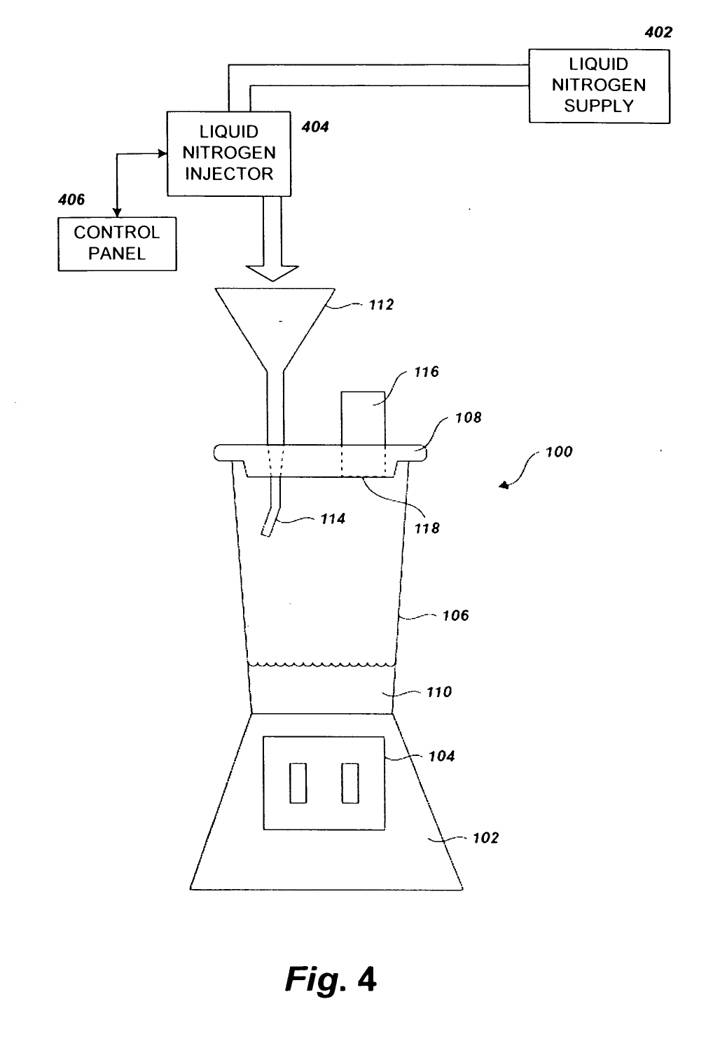

The fill tube 112 is exemplary in nature and may be any of a variety of shapes and sizes. The one depicted is shaped as a funnel to aid a user who may be pouring liquid nitrogen, or other cryogenic fluid, into the blender container 106. Such a funnel shape for the fill tube 112 will protect the user from the cryogenic fluid and quickly deliver that fluid to the discharge outlet 114 and then into the container 106. One alternative, not shown, is that the discharge outlet 114 may be directly connected to a delivery hose or similar source that delivers a metered charge of liquid nitrogen such as, for example, by using the liquid nitrogen dosing system described in U.S. Pat. No. 5,743,096 (herein incorporated by reference in its entirety). Such an arrangement would avoid a user having to measure liquid nitrogen and pour the liquid nitrogen when operating embodiments of the present invention and is described in more detail below with respect to FIG. 4.

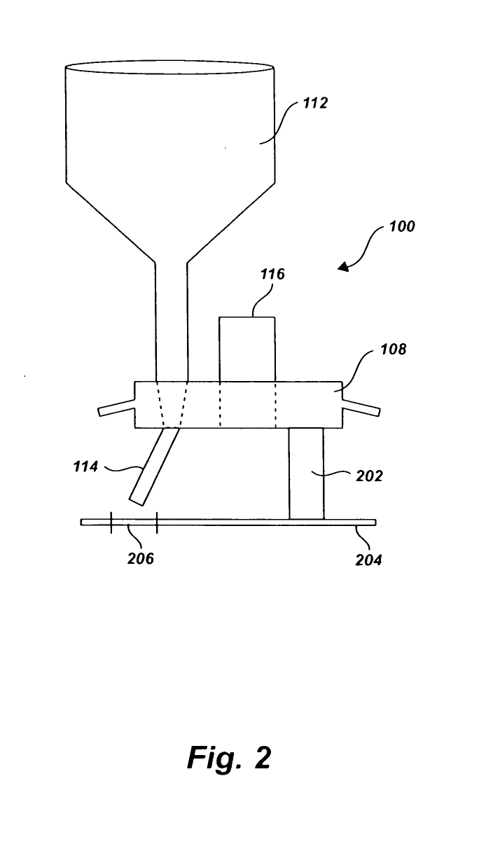

The blender 100 of FIG. 1 is shown as an entire unit. However, the principles of the present invention may be embodied in a lid, as shown in FIG. 2, which can be used with any compatibly sized blender. FIG. 2 also depicts aspects of the discharge outlet 114 and chimney 116 in more detail than is shown in FIG. 1. Also, the blender shown in FIG. 1 happens to have a container 106 formed with four walls much like a square. One of ordinary skill will recognize that other shaped containers may be used (e.g., cylindrical) without departing from the scope of the present invention.

As mentioned, the lid of FIG. 2 includes more details than the drawing of FIG. 1. The chimney 116, fill tube 112, and discharge outlet 114 are similar to that of FIG. 1. However, also shown is deflector plate 204 with a support 202. Furthermore, centered around the end of the discharge outlet 114 is an opening 206 within the deflector plate 204. The purpose of the deflector plate 204 is to prevent splash back of the liquid nitrogen onto the discharge outlet 114 which might freeze and clog the discharge outlet 114. The deflector plate 204 may be of any material that is rigid and can withstand being splashed with liquid nitrogen. The support post 202 holds the deflector plate 204 at a predetermined distance from the end of the discharge outlet 114. For example, there may be about a ¼ inch gap between the end of the discharge outlet 114 and the top of the deflector plate 204. However, this distance is approximate and may be changed without departing from the scope of the present invention. Furthermore, the support post 202 may be adjustable in length (for example, through a screw-type mechanism) to allow the height of the deflector plate 204 to be adjusted.

The size and location of the hole 206 is designed to permit the liquid nitrogen to leave the end of the discharge outlet 114 without obstruction in order to enter the blender container 106. Also, the resulting vapors can pass through the hole 206 and around the edges of the deflector plate 204. In one exemplary lid apparatus as shown in FIG. 2, the following approximate dimensions are contemplated: the fill tube may hold about 20 oz., the chimney 116 has an inner diameter of about one inch and extends above the lid 108 by about an inch or more, the discharge outlet 114 has an inner diameter of about ⅛^{th} inch, the hole 206 in the deflector plate is about ½ inch in diameter, and the distance between the deflector plate 204 and the end of the discharge outlet 114 is about ¼ inch. As depicted, the discharge outlet 114 is bent towards the side of the container 106. The angle of bending is based on the size and shape of the container 106. In later described embodiments, the outlet 114 is omitted and a direct injector injects the liquid nitrogen into the blender container 106. Whether injected or delivered through the outlet 114, the liquid nitrogen is delivered to approximately the lowest point of the blending vortex within the blender container 106. This reduces splash up and keeps the contents 110 from freezing prematurely. These dimensions may vary without departing from the scope of the invention; in particular, the nominal sizes of the chimney 116 and the discharge outlet 114 may vary greatly as long as their relative sizes maintain the flow of liquid nitrogen and exhaust gases such that the exhaust gases are expelled forcefully to create a visual effect. These above provided dimensions are beneficial for a typically sized commercial blender that can make a single smoothie serving. Other dimensions would be appropriate for different sized blenders and are contemplated within the scope of the present invention. Additionally, the size of the chimney 116, in particular, may be varied to control the height at which the liquid nitrogen vapors are expelled into the surrounding environment. By making the opening of the chimney 116 smaller, the height of the escaping vapors can be increased; alternatively, making the chimney 116 larger can decrease the height at which the vapors are expelled.

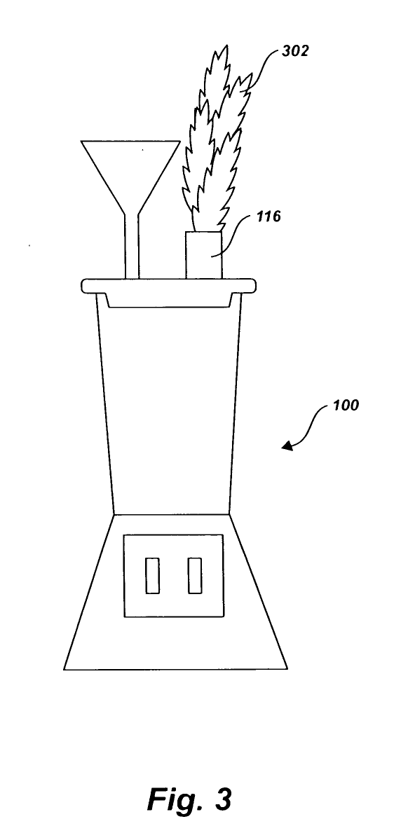

In operation, a user pours contents 110 into the container 106 and places the lid on the blender 100. The blender is then turned on. There can be a pre-programmed speed/power cycle or the blender 100 may be manually operated. For a 16 oz. smoothie or milkshake, about 7 to 8 oz. of liquid nitrogen is then poured into the blender in order to partially freeze the contents 110. For an 8 oz smoothie or milkshake, 3½ to 4 oz. of liquid nitrogen may be used. If ice cream, rather than a smoothie is being made, then an extra 2 oz. of liquid nitrogen may be added. Similar ratios of liquid nitrogen to smoothie size may be observed without departing from the scope of the present invention. As for processing times and speeds, that varies by what product is being made. However, the operation of the blender with respect to the exhausting of liquid nitrogen vapors remains the same. The size of the discharge outlet 114 allows liquid nitrogen to enter at a rate that causes exhaust gases within the container 106 to form at such a rate that the exhaust gases 302 (see FIG. 3) are forcefully expelled upward from the chimney 116 such that the gases are visible for between one to three feet above the blender 100 and an audible effect is created as well. In this manner, the making of the smoothie will entertain and draw the attention of a customer and other bystanders. According to the principles of the present invention, the exhaust gases 302 do not merely drift up from the chimney 116 but, instead are forcefully expelled to create a visual effect and sometimes an audible effect.

As previously mentioned, embodiments of the present invention may include an automatic liquid nitrogen injector that accurately provides an appropriate amount of liquid nitrogen to the blender. Such an arrangement is depicted in FIG. 4. In particular, blender 100 is a microprocessor controlled blender and receives injected liquid nitrogen from the injector 404. A user, via a control panel 406 for the injector 404, controls the amount and timing of liquid nitrogen that is injected into the blender 100. As shown, the injector is coupled with a liquid nitrogen source 402 which may be a replaceable cylinder or the like.

The benefit of the arrangement of FIG. 4 is that the liquid nitrogen injection can be accurately controlled and can be repeatedly reproduced accurately every time the blender 100 is used. Furthermore, the microprocessor controlled blender 100 can repeatedly and accurately run an appropriate program cycle for each type of confection that is being made. As a result, the present system eliminates all the quality control issues present if a user were to pour by hand the liquid nitrogen. Also eliminated are the quality control issues related to a user repeatedly opening the blender, checking to see if the confection is complete, running the blender some more, checking it again, etc.

Two appropriate liquid nitrogen injectors include those described in U.S. Pat. Nos. 6,182,715, 6,047,553 and 5,743,096; the disclosures of which are incorporated herein by reference. The previous description is provided to enable any person skilled in the art to practice the various embodiments described herein. As for blenders, the Vitamix “Blending Station” model and the Blendtec “The Smoother” model both permit appropriate microprocessor control of the blend program useful in the present invention. With these features, the system shown in FIG. 4 can uniformly produce identical results each time it is used and such results are effectively independent from the skill and knowledge of the operator.

Typical delivery of liquid nitrogen often includes fluctuating pressures, therefore, the inclusion of the injectors described above help ensure the liquid nitrogen is precisely and accurately delivered to the blender at ambient pressure. Because the present system ensures the liquid nitrogen is delivered at a consistent pressure and volume, the quality, texture and consistency of the resulting confection is improved. The microprocessor controlled variable speed blenders mentioned above permit a very low start speed followed by a higher speed burst. If the blender starts out too fast, then the liquid is splattered before it starts to harden. Furthermore, if blending occurs for too long then friction and heat cause the product to melt but blending for too short of a time may make a product have an unwanted consistency or texture because the liquid nitrogen is not properly incorporated. Additionally, the Blendtec blender mentioned earlier, and similar models, allow consistent low speed throughout mixing. The consistent low speed keeps the temperature down within the blender container 106 and reduces melting which improves texture and consistency of the resulting product. Furthermore, the low speed mixing helps minimize noise from the blender which can be beneficial in various environments.

For an 8 ounce ice cream serving, 8 ounces of refrigerated cream is placed in the blender along with any desired flavorings. The blender blends at its lowest speed for 18 seconds. The injector adds 8 ounces of liquid nitrogen at a rate that the injection ends in 18 seconds (i.e., the time of blending). Finally, a high speed burst throws the ice cream against the wall of the blender making it easier to scrape out.

To make 12 ounces of ice cream, 12 ounces of cream are used along with 12 ounces of liquid nitrogen. A similar speed and burst cycle is used as described above but for a duration of 24 seconds.

For 16 ounce smoothies and milkshakes, 16 ounces of cream or 6 ounces of fruit puree and 10 ounces of fruit juice are used along with 8 ounces of liquid nitrogen. The 18 second blending program described above is then used to complete the confection.

The embodiments described herein include a microprocessor controlled blender and a microprocessor controlled liquid nitrogen injector. The control of these two systems may be synchronized so that blending occurs at certain times that nitrogen is being injected. Furthermore, the injection rate of the nitrogen can be controlled as well. In particular, the liquid nitrogen injection systems discussed so far include various sized orifices on the injector nozzle and, therefore, the size can be selected to allow an appropriate flow rate of liquid nitrogen.

For example, an orifice size of about 0.075 to about 0.10 inches provides a beneficial flow of liquid nitrogen in most instances and, in general, sizes from about 0.070 to about 0.15 inches can be adapted for most uses. Smaller sized orifices will reduce the flow and thereby prevent enough liquid nitrogen to reach the material being frozen. Because the blending action will warm the material being blended, the result will be relatively runny (which for some confections may be appropriate). If the orifice size is so large as to allow the liquid nitrogen to flow too fast, then the material may explode out of the blender or freeze too fast and prevent a smooth, blended result. In the example recipes above, an orifice size of about 0.10 inches will provide a continuous rate of liquid nitrogen that will total 8 oz. in about 18 seconds (and 12 oz. in about 24 second) at ambient pressure.

One purpose of the funnel described earlier allowed a large amount of liquid nitrogen to be dispensed at once but whose flow into the blender is controlled by the size of the exit hole of the funnel. This funnel can continue to be used with the injector if a large injector orifice is used or, alternatively, the funnel can be eliminated and the injector be connected directly into an input port of the blender lid by properly sizing the orifice.

With the computer controlled system, as described later, a mix algorithm may be developed that synchronizes the blending times and the injection of liquid nitrogen. The variables considered when developing a mixing algorithm to be implemented are such things as size of the resulting confection, the material being frozen, the temperature of the material being frozen, size of the blender, injector size, and the resulting product that is desired.

One way to implement different mix algorithms is to consider the algorithm to be include multiple channels each having 10 steps (although fewer or more steps are contemplated within the scope of the present invention). Each step can have an associated duration and an associated state and each “channel” relates to a physical parameter being controlled. For example, one channel can be for the liquid nitrogen injector and another channel for the blender motor. Additional channels can be added that control devices such as blinking lights, sounds, vapor, graphic displays, etc. For example, step one of the liquid nitrogen injector may be “10 seconds: ON” with step 2 being “3 seconds: OFF”. These steps would result in the injector providing liquid nitrogen for 10 seconds and then remaining off for the next 3 seconds.

Translating this particular implementation to one of the recipes described above, the algorithm for making 8 oz. of ice cream, the first step for the liquid nitrogen control channel would be “18 seconds: ON” and the second step would be “OFF” (the lack of a duration value informs the machine the algorithm is finished). The first step for the blender motor would be exactly the same “18 seconds: ON”. This algorithm would result in 8 oz. of liquid nitrogen being injected in about 18 seconds and the blender running for the entire time. For the smoothie, the steps for both the blender motor and the liquid nitrogen injector could be something similar to:
STEP 1: 3 seconds: ON
STEP 2: 2 seconds: OFF
STEP 3: 3 seconds: ON
STEP 4: 3 seconds: OFF
STEP 5: 8 seconds: ON
STEP 6: OFF
   One of ordinary skill will recognize that the above times are approximate and the values can be varied without departing from the scope of the present invention. Also, contrary to the above example, the blender motor steps do not have to be the same as the liquid nitrogen injection steps and, therefore, for example, STEP 1 (or any of the steps) for the injector may differ in duration compared to a corresponding step for the blender and can vary in value (ON/OFF) as well. This specific implementation provides a robust way to synchronize the operation of the different devices (e.g., blender, injector, lights, etc.).

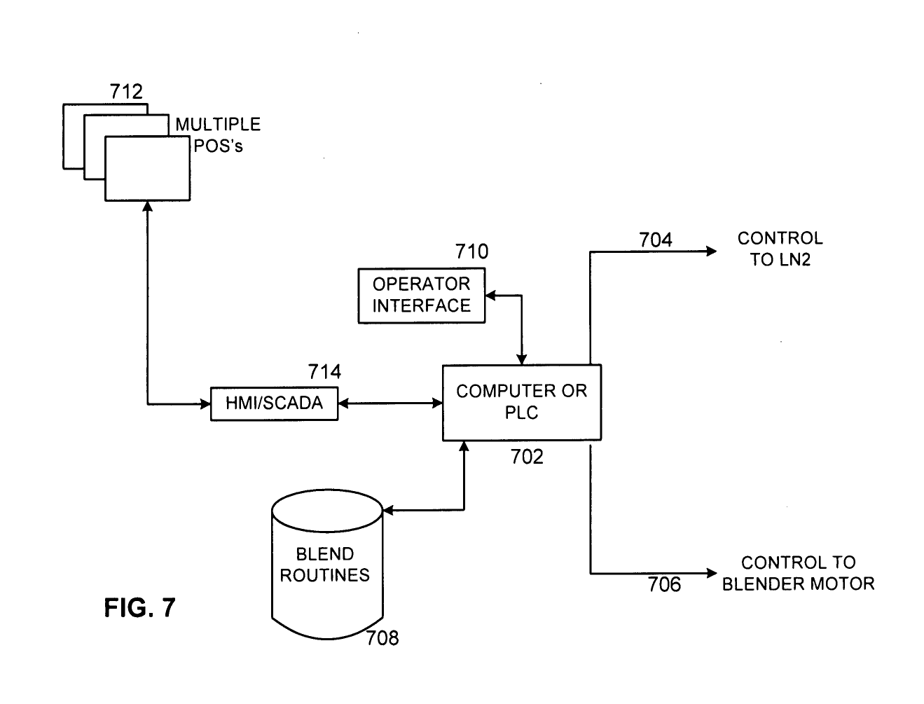

Under the control of the PLC or computer (shown as 702 in FIG. 7), the ON/OFF states can be translated via relays or other connections to physical control signals that operate a solenoid or motor or other device. Thus, multiple channels each having multiple steps can be defined so that a mix algorithm can be developed that synchronizes the operation of a blender motor, the injection of liquid nitrogen, and the operation of other devices during the blending of a product. The mix algorithm can be stored in any of a variety of electronic formats that can be retrieved and utilized by the PLC or computer 702.

For example, if a typical 96 oz blender is used, then 12 oz of cream can be injected with about 12 oz of liquid nitrogen without exploding from the blender in the 24 second blending program described above. However, when 16 oz of cream are present, a continuous stream is too fast for the blender and results in the material and liquid nitrogen escaping from the blender. In this instance, the liquid nitrogen can be injected at various ON/OFF cycles during the blending cycle. The orifice size of the injector and the length of the blending cycle are selected so that sufficient amount of liquid nitrogen are added to create the desired result and in such a way that the result does not explode, is well blended, and can be consistently repeated.

In another example, a 16 oz smoothie which receives 8 oz of liquid nitrogen has its blending cycle controlled differently than a blending cycle which creates 8 oz ice cream with 8 oz liquid nitrogen. Because of the room temperature and the heat of the blender, the ice cream must not be allowed to melt during creation while the smoothie is acceptable with a much runnier consistency. Thus, the 16 oz. smoothie can have 2 to 4 second on/off bursts of liquid nitrogen injection, whereas the ice cream will receive a continuous stream. The bursts of liquid nitrogen can be increased to 5 to 7 seconds later in the mixing cycle as the product thickens and the risk of explosion is minimal.

Another factor in the blending algorithm selected for a product is the material being blended. Although dairy products have been discussed up to this point, blended alcohol drinks may be created as well. The starting temperature of the alcohol (as well as its freezing point) affect the blending cycle and the amount of liquid nitrogen needed to reach a desired end product.

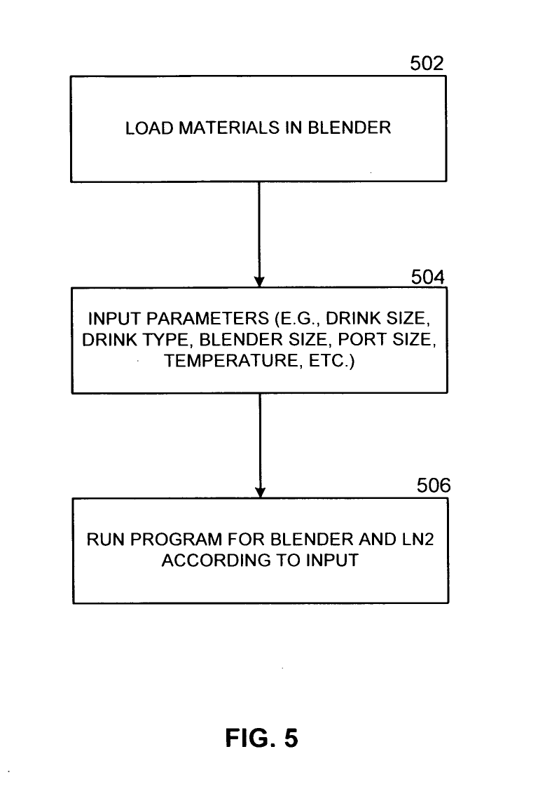

FIG. 5 shows an algorithm of blending products in accordance with the principles of the present invention. As described previously, a blender apparatus is used and, in step 502, the apparatus is loaded with the materials to be blended. In step 504, an operator inputs a variety of different variables that will be used to select an appropriate blending algorithm. Some of these variables may be preset. For example, if the blender size and the injector orifice size is predetermined, then the operator may not be allowed to change these. Although a supervisor, service technician, or other personnel may be authorized to update or change these in appropriate circumstances. Thus, there is an interface screen or menu which allows the user to input this information. Preferably, a graphical user interface or cash-register like interface having pre-programmed buttons can be used to simplify input from among the different permutations that are possible.

Based on the input parameters provided by the operator, an algorithm for the blender and the liquid nitrogen injector is selected to produce the desired end product, in step 506. As a result, the timing of the injection of the liquid nitrogen, the amount of the liquid nitrogen, and whether the blender is on or off can all be synchronized to provide a consistent product without the operator needing to be highly skilled or trained.

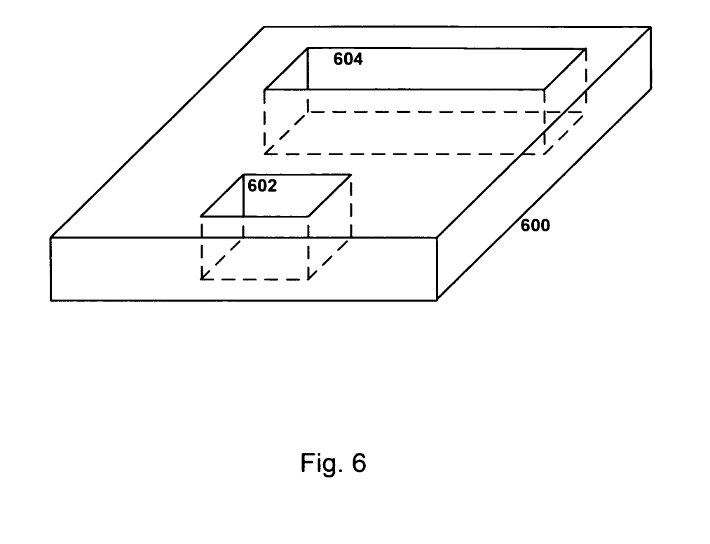

As a result of controlling the injection of the liquid nitrogen and synchronizing it with the blender operation, the funnel aspect of the blender lid described earlier can be eliminated entirely. For example, the lid 600 of FIG. 6 includes an input port 602 for directly receiving the injector port of the liquid nitrogen injector and an output port 604 through which the liquid nitrogen escapes upward in a visually exciting manner.

FIG. 7 provides a block-level view of the components of embodiments of the present invention. A computer 702 can encompass a dedicated computer or microprocessor-controlled system or can be a portion of a general computer system. Additionally, the computer 702 can be a PLC or a microcontroller-based system specifically designed to interface with a blender and a liquid nitrogen injector. An operator interface 710 (e.g., a touch screen, keyboard, etc.) is used by an operator to input parameters to the computer 702 regarding a confection being prepared. Based on the parameters, and possibly pre-stored default values, the computer 702 selects an appropriate blend routine 708 to prepare the confection. The blend routine 708 is executed by the computer 702 and results in control signal being sent to the liquid nitrogen injector and the blender. In particular, a control signal 704 to the injector controls it to dispense liquid nitrogen at certain times in certain amounts while a control signal 706 controls the operation of the blender motor such as whether it is on or off and, if on, the speed at which it runs. Thus, the computer 702 can synchronize the operation of the liquid nitrogen injector and the blender motor to achieve a consistent and desired confection every time the system operates.

FIG. 7 depicts one possible environment in which embodiments of the present invention can be employed. In particular, there may be multiple point-of-sale terminals 712 that connect to the computer 702. This interface can be through recognized protocols such as HMI and SCADA 714 or can be through proprietary protocols as well. Although not shown, the computer 702 may be utilized to control more than one blender merely by having separate control lines for the blender motor and liquid nitrogen injector for each blender. As a result, multiple transactions at the terminals 712 can be directed in a controlled manner to the blender so that it can service input from multiple users.

One of ordinary skill will recognize that other recipes may be used depending on the size of the confection and the desired texture. However, these examples are provided to indicate the amount of base product, amount of liquid nitrogen, and blending speeds all are controlled to ensure a consistent, uniform product is produced every time the system is used. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A system comprising:
a blender having a container and a motor,
a liquid nitrogen injector configured to inject liquid nitrogen into the container; and
a computer in communication with the motor and the liquid nitrogen injector and configured to synchronize operation of the motor and the liquid nitrogen injector.

2. The system of claim 1 further comprising:
a user interface in communication with the computer configured to provide at least one parameter related to operation of the motor and the liquid nitrogen injector.

3. The system of claim 1, further comprising:
a lid configured to fit on the container and having a first opening for receiving liquid nitrogen from the liquid nitrogen injector.

4. The system of claim 3, wherein the lid further comprises a second opening configured to exhaust boiling liquid nitrogen out of the container.

5. The system of claim 2, wherein the at least one parameter includes a size of the container.

6. The system of claim 2, wherein the at least one parameter includes a size of a confection to be mixed in the container.

7. The system of claim 2, wherein the at least one parameter includes a starting temperature of a raw material to be mixed in the container.

8. The system of claim 2, wherein the at least one parameter includes a type of confection to be mixed in the container.

9. The system of claim 2, wherein the at least one parameter includes a port size of the liquid nitrogen injector.

10. The system of claim 2, wherein the computer is configured to select a blend routine based on the at least one parameter.

11. The system of claim 10, wherein the blend routine includes one or more instructions for the computer related to how much liquid nitrogen to inject.

12. The system of claim 10, wherein the blend routine includes one or more instructions for the computer related to how long to operate the motor.

13. The system of claim 10, wherein the blend routine includes one or more instructions for the computer related to a frequency and duration for periodically injecting liquid nitrogen.

14. The system of claim 10, wherein the blend routine includes one or more instructions for the computer related to a frequency and duration for periodically operating the motor.

15. The system of claim 14, wherein the blend routine includes one or more instructions for the computer related to a speed at which to operate the motor.

16. The system of claim 10, wherein the blend routine includes one or more instructions for the computer related to synchronizing the operation of the liquid nitrogen injector and the operation of the motor.

17. A system comprising:
a blender having a container and a motor,
a liquid nitrogen injector configured to inject liquid nitrogen into the container;
a computer in communication with the motor and the liquid nitrogen injector and configured to synchronize operation of the motor and the liquid nitrogen injector.
a user interface in communication with the computer configured to provide at least one parameter related to operation of the motor and the liquid nitrogen injector; and
a plurality of blend routines executable by the computer and each including one or more instructions related to synchronizing the operation of the liquid nitrogen injector and the motor.

18. The system of claim 17, wherein the computer is configured to select one of the plurality of blend routines based on the at least one parameter.

19. The system of claim 17, wherein an orifice of the liquid nitrogen injector has a size from about 0.070 to about 0.15 inches.

20. A method of making a frozen confection comprising the steps of:
receiving at least one parameter related to the frozen confection;
selecting a blend routine based on the at least one parameter;
mixing one or more raw materials in a container to make the frozen confection;
injecting liquid nitrogen into the container while mixing occurs; and
controlling the mixing and the injecting concurrently based on the blend routine.
